(19) United States
(12) Patent Application Publication
(10) Pub. No.: US 2005/0108169 A1
(43) Pub. Date: May 19, 2005

(54) Contract based enterprise application services

(76) Inventors: Mukund Balasubramanian, Cupertino, CA (US); Patrick Vallaeys, Los Altos, CA (US); Jeff Tonkel, Saratoga, CA (US); Rajesh Koilpillai, Chennai (IN)

Correspondence Address: CARR & FERRELL LLP, 2200 GENG ROAD, PALO ALTO, CA, 94303, US

(21) Appl. No.: 10/863,773

(22) Filed: Jun. 7, 2004

Related U.S. Application Data
(60) Provisional application No. 60/520,230, filed on Nov. 14, 2003.

(51) Int. Cl. H04L 9/00

(52) U.S. Cl. 705/50

(57) ABSTRACT

The invention includes systems and methods of facilitating interaction between service consumers and services providers based on service contracts. These service contracts are established by considering preferences, capabilities or limitations of each service consumer and at least one characteristic of each service provider. Once the preferences, capabilities or limitations of a service consumer are determined these may be used to automatically established individualized service contracts with a variety of service providers. The services contracts may include contract terms relating to data format, communication protocol, security, data logging, load balancing, service level agreements, service quality, performance requirements, or the like.

### CROSS-REFERENCE TO RELATED APPLICATIONS

This application claims benefit of commonly owned U.S. Provisional Patent Application No. 60/520,230, entitled “Contract Based Enterprise Application Services” and filed Nov. 14, 2003. The disclosure of which is herein incorporated by reference.

### BACKGROUND

1. Field of the Invention

The invention is in the field of enterprise applications on computer networks and more specifically in the field of enterprise application interfaces.

2. Related Art

Computer networks first became successful because of the advantages and convenience of transferring data between computers. Building on this success, systems have been developed wherein the transferred data is associated with remote execution of applications over a computer network. For example, in some cases, network applications are hosted by an application service provider and accessed via a network client. Network applications may be shared by several users, allow the use of thin clients, and may be easier to maintain than numerous copies of an executable distributed among many computers. This architecture may be applied to both extranets and intranets.

The architectures used by application service providers are typically similar to that of a website accessed by clients over the internet. Each interaction between a service provider and a service consumer is based on a communication protocol demanded by the network application and each communication session is based on a one-to-many relationship between the one service provider and possibly many service consumers. For example, in a typical system, a network application is implemented with a specific policy regarding how it communicates and responds to data from any service consumer. This policy prescribes factors such as communications, security, available services, and data exchange standards. All service consumers are subject to the same policy and are thus treated equally. In some cases, the policy may allow an individual service consumer to use a user identifier to access data associated with a specific user account. This data may be private to the service consumer, may provide password control, and may be used to customize a visual interface, but is not used to change the underlying policy that governs interaction between the service provider and any service consumer.

FIG. 1 illustrates a prior art architecture including a variety of service consumers and service providers communicating through a computer network. The service consumers include a Portal 110, a B2B (business to business) Exchange 120, and a Customer Service Interface 130. These service consumers use a Network 140, such as the internet, to request and receive services from service providers including, for example, an ERP (enterprise resource planning) Service 150, a CRM (customer relationship management) Service 160, and a Financial Service 170. Each service provider interacts with potentially many service consumers on a one-to-many basis under a policy associated with the service provider.

When only one type of service consumer uses a particular service provider the fixed policy of the particular service provider may be advantageous. Any service consumer knowing the policy can access the service and all service consumers are treated the same. A service consumer may even be anonymous. However, when a variety of different service consumers use the same service provider, the single policy architecture is a significant disadvantage. Portal 110, B2B Exchange 120 and Customer Service Interface 130 may all want to use ERP Service 150, but the demands of each of these service consumers are likely to be different. For example, considering just authentication of service, consumers Portal 110 may need to use a user identifier and password entered through the portal, B2B Exchange 120 may need to use an authentication certificate, and Customer Service Interface 130 may need to use some other authentication or security scheme. A fixed authentication policy, as used in the prior art, does not allow for this variation. This problem arises because all service consumers are subject to the same authentication routines established by ERP Service 150.

FIG. 2 illustrates an alternative architecture of the prior art. In this architecture, a Service Interface 210 is used as an interface between the service consumers and the service providers. Service Interface 210 may be used to establish one policy shared by the service providers and may be able to perform simple operations such as data format conversion. One common protocol is an access protocol named SOAP (simple object access protocol). SOAP is a lightweight protocol for exchange of information between service consumers and service providers in a network environment. SOAP is an XML based protocol including policies defining how data can be packaged and communicated. The definition specifies three parts: an envelope that defines a framework for describing what is in a message and how to process it; a set of encoding rules for expressing instances of application-defined data types; and a convention for representing remote procedure calls and responses. Data received using the SOAP protocol may be converted to an alternative format by Service Interface 210 before being passed to one of the service providers shown in FIG. 2.

While Service Interface 210 and protocols such as SOAP can handle simple variations in data format they are inadequate for handling many of the other problems that occur in multi-service consumer/multi-service provider environments. For example, the problem of conflicting authentication needs discussed above is not solved by addition of Service Interface 210. Rather, Service Interface 210 merely moves the problem to a different location in the architecture. Service Interface 210 still treats each service consumer in the same way, regardless of the each service consumer's particular needs or preferences.

The above problems are magnified in systems involving multiple service consumers and multiple service providers. There is a need for improved methods of interaction between service consumers and service providers in network based applications.

### SUMMARY OF THE INVENTION

The invention includes systems and methods of facilitating interaction between service consumers and services providers based on service contracts. These service contracts are established by considering preferences, capabilities or limitations of each service consumer and at least one characteristic of a service provider. Through these service contracts, each service provider/service consumer interaction may be subject to an individualized set of interaction policies (e.g., set of service contract terms).

Preferences of a service consumer include things that are preferred but not required by a service consumer. For example, in one embodiment, preferences include preferred methods of exchanging data. A service consumer may prefer to exchange data in a specific format or using a specific protocol. Capabilities include what a service consumer is capable of doing. For example, a specific service consumer may be capable of using three particular alternative encryption routines and one particular data compression routine. Limitations include excluded capabilities. For example, a service consumer may not be able to utilize RPC (remote procedure call) service or may only be able to communicate using SSL (secure socket layer) protocols.

Service contracts are typically based on one or more characteristics of the service provider and the preferences, capabilities or limitations of a service consumer. For instance, in some embodiments, contracts are determined using a service provider characteristic and preferences of the service consumer. In some embodiments, contracts are determined using a service provider characteristic, and capabilities and limitations of the service consumer. In some embodiments, contracts are determined using a service provider characteristic, and preferences, capabilities and limitations of the service consumer.

Once specified, the preferences, capabilities or limitations of a service consumer may be used to establish more than one service contract with more than one service provider. Thus, the specified information may be reused to establish custom interaction characteristics for a variety of service providers. Each service consumer/service provider interaction may be performed under different service contract terms (e.g., a different service policy) that are responsive to both the service provider and the service consumer.

Various embodiments of the invention include a network application system comprising a service broker configured to act as an intermediary between a service provider and a service consumer, the service consumer having an identity and being characterized by a) a consumer preference, and/or b) a consumer limitation and a consumer capability, the service broker including an input/output configured to exchange service consumer data with the service consumer and to exchange provider data with the service provider, a memory configured to store service contract data selected using the service consumer identity and generated responsive to a characteristic of the service provider and the consumer preference, consumer limitation or consumer capability, of the service consumer, and a mechanism configured to use the contract data to process the service consumer data and the provider data according to the service contract data.

Various embodiments of the invention include a method of operating a network application system, the method comprising providing a service consumer identity to a service broker, the service consumer identity configured for the service broker to select first service contract data characterizing a first service contract, the selected first service contract data being responsive to a preference, a capability or a limitation of the service consumer, and a characteristic of a service provider, and communicating between the service consumer and the service provider response to a term of the first service contract.

Various embodiments of the invention include a method of operating a network application system, the method comprising receiving a service consumer identity from a service consumer, the service consumer identity configured for selecting service contract data, selecting first service contract data responsive to the service consumer identity, the selected first service contract data being responsive to a preference, a capability or a limitation of the service consumer and a characteristic of a service provider, communicating with the service consumer under a service contract term characterized by the service contract data, and communicating with the service provider under a service contract term characterized by the service contract data.

Various embodiments of the invention include a method of operating a network application system, the method comprising receiving a service consumer identity from a service consumer, selecting service contract data from a plurality of service contract data using the service consumer identity, the selected service contract data being responsive to a preference, a capability and a limitation of the service consumer, and a characteristic of a service provider, storing the service contract data in local memory in a pre-compiled format, receiving first communications from the service consumer, processing the first communications using the stored service contract data, sending a result of processing the first communications to the service provider, receiving second communications from the service provider responsive to the sent result of processing the first communication, processing the second communications using the stored service contract data, and sending a result of processing the second communications to the service consumer.

Various embodiments of the invention include a method of operating a network application system, the method comprising receiving a first service consumer identity from a first service consumer, the first service consumer identity configured for selecting first service contract data, the selected first service contract data being previously determined using a configuration engine responsive to a preference, a capability or a limitation of the first service consumer, and a characteristic of a first service provider, the preference including a preferred data format, the capability including an encryption capability, and the limitation concerning a communication protocol, pre-compiling the first service contract data for run-time use, communicating between the first service consumer and the first service provider based on the pre-compiled first service contract data, receiving a second service consumer identity from a second service consumer, the second service consumer identity configured for selecting second service contract data, the selected second service contract data being different than the selected first service contract data and being configured to specify terms by which the first service provider provides services to the second service consumer, pre-compiling the second service contract data for run-time use, and communicating between the second service consumer and the first service provider based on the second service contract data.

Various embodiments of the invention include a method of operating a network application system, the method comprising receiving a first service consumer identity from a first service consumer, the first service consumer identity configured for selecting service contract data previously determined using a configuration engine responsive to a preference, a capability or a limitation of the first service consumer, and a characteristic of a service provider, receiving a first service request from the first service consumer, selecting a first service provider responsive to the first service request, the first service provider having a characteristic, selecting first service contract data responsive to the service consumer identity and the characteristic of the first service provider, communicating between the first service consumer and the first service provider based on the selected first service contract data, receiving again the first service consumer identity from the first service consumer, receiving a second service request from the first service consumer, selecting a second service provider responsive to the second service request, the second service provider having a characteristic, selecting second service contract data responsive to the service consumer identity and the characteristic of the second service provider, the second service contract data being different than the first service contract data, both the first service contract data and the second service contract data being responsive to a preference, a capability or a limitation of the service consumer, and communicating between the first service consumer and the second service provider based on the selected second service contract data.

Various embodiments of the invention include a system comprising means for receiving a service consumer identity from a service consumer, the service consumer identity configured for selecting service contract data, means for selecting first service contract data responsive to the service consumer identity, the selected first service contract data being responsive to a preference, a capability or a limitation of the service consumer and a characteristic of a service provider, means for communicating with the service consumer under a service contract term characterized by the service contract data, and means for communicating with the service provider under a service contract term characterized by the service contract data.

Various embodiments of the invention include a computer readable medium having thereupon computer instructions comprising a code segment configured for receiving a service consumer identity from a service consumer, the service consumer identity configured for selecting service contract data, a code segment configure for selecting first service contract data responsive to the service consumer identity, the selected first service contract data being responsive to a preference, a capability or a limitation of the service consumer and a characteristic of a service provider, a code segment configure for communicating with the service consumer under a service contract term characterized by the service contract data, and a code segment configure for communicating with the service provider under a service contract term characterized by the service contract data.

### BRIEF DESCRIPTION OF THE VARIOUS VIEWS OF THE DRAWINGS

FIG. 1 illustrates a prior art architecture including a variety of service consumers and service providers communicating through a computer network;

FIG. 2 illustrates an alternative architecture of the prior art;

FIG. 3 is a block diagram illustrating a network application system configured to provide network application services to one or more service consumers, according to various embodiments of the invention;

FIG. 4 is a flow chart illustrating a method of operating a network application system, according to various embodiments of the invention;

FIG. 5 is a flow chart illustrating further methods of operating a network application system, according to various embodiments of the invention;

FIG. 6 illustrates various embodiments of the invention in which a service provider provides application services to more than one service consumer; and

FIG. 7 illustrates various embodiments of the invention in which a service consumer obtains application services from two different service providers under different service contract terms.

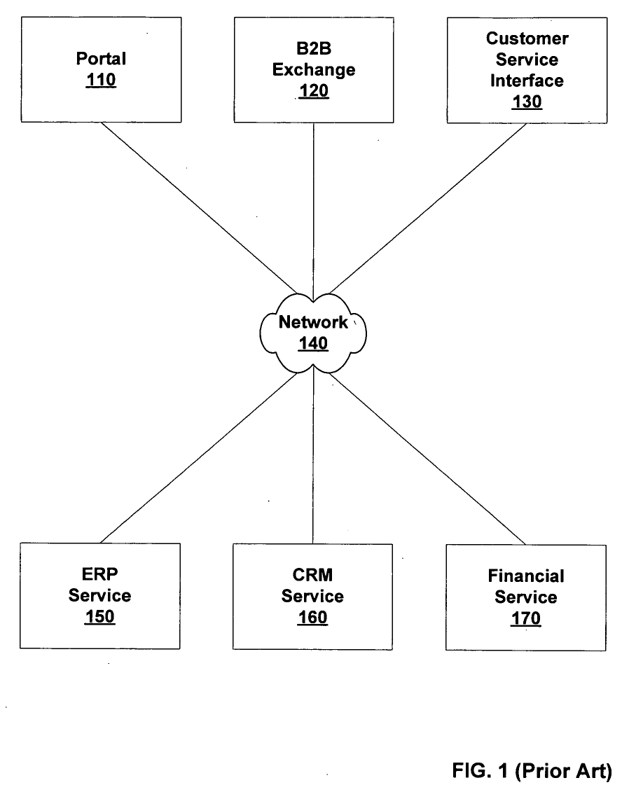

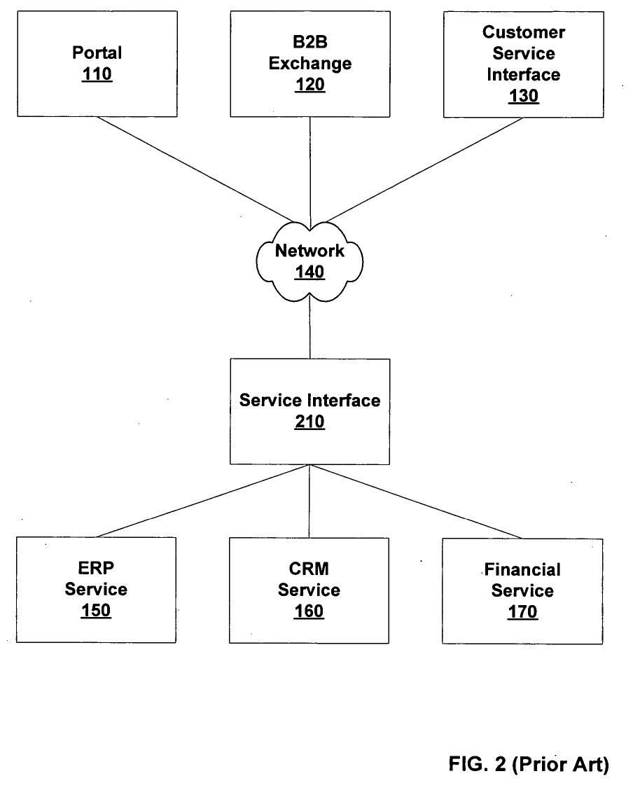

### DETAILED DESCRIPTION

The invention includes systems and methods by which a service consumer and a service provider interact based on a service contract. The service contract is determined by considering one or more preference, capability or limitation of the service consumer and at least one characteristic of the service provider. The service contract may be determined beforehand or in real-time at the start of an interaction.

In some embodiments, a term of a service contract is determined by comparing one or more preferences of the service consumer with a capability or requirement of the service provider. For example, the service consumer may prefer using an HTTPS protocol (hypertext transfer protocol, secure) rather than an HTTP protocol (hypertext transfer protocol) and the service provider may be capable of using either protocol. A resulting term within a service contract may be that their interaction will use HTTPS. In some embodiments, a term of a service contract is determined using a capability and a limitation of the service consumer. For example, if the service consumer is capable of communicating using SMTP (simple mail transfer protocol) and FTP (file transfer protocol) and is not capable of using JMS lava message service), then a resulting service contract term may specify use of SMTP or FTP but not JMS. In some embodiments, a term of a service contract is based on all three factors (preference, capability and limitation) relating to a service consumer. Different terms within the same contract may be based on different factors. In some instances, capabilities and limitations are considered after consideration of a preference has failed to result in an agreed upon contract term. In this case, communication between the service consumer and the service broker may be made using JMS, while communication between the service broker and the service provide may be performed responsive to communication protocol capabilities of the service provider.

A service contract is also determined with consideration of at least one characteristic of the service provider. This characteristic may be a preference, capability, limitation, requirement, or the like. In some embodiments, the characteristics of the service provider are available as a contracting option. However, in contrast with the policies of the prior art, this contracting option is configured for determining terms of a service contract, not for dictating conditions of any interaction. As such, the contracting option of the invention is more flexible than the policies of the prior art, and typically the contracting option alone is insufficient for determining all terms of a service contract. As described further herein, determination of all terms of a service contract requires information regarding one or more preference, capability or limitation of the service consumer.

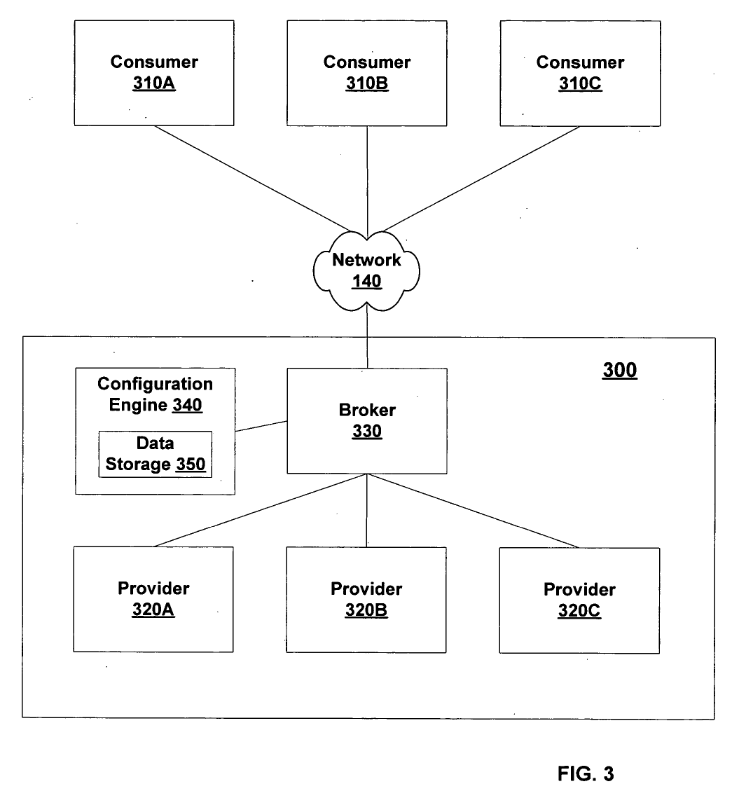

FIG. 3 is a block diagram illustrating a Network Application System 300 configured to provide one or more network application services to one or more service consumers, such as one of Consumers 310A-310C. In some embodiments, these service consumers include a portal, a B2B exchange, a customer service interface, or the like. Network Application System 300 includes one or more service providers, such as one of Service Providers 320A-320C. Service Providers 320A-320C are configured to communicate with Consumers 310A-310C via Network 140 and a Broker 330. In various embodiments, all or part of Broker 330 is associated with an independent third party and/or with one of Consumers 310A-310C, rather than with Network Application System 300 as shown in FIG. 3.

Consumers 310A-310C each have an identity and are characterized by service consumer data including at least a consumer preference, and/or a consumer limitation and a consumer capability. (e.g., In some embodiments, Consumer 310A is characterized by a consumer preference, Consumer 310B is characterized by a consumer limitation and a consumer capability, and Consumer 310C is characterized by a consumer preference, a consumer limitation and a consumer capability.) Each identity is configured to associate service consumer data with one member of Consumers 310A-310C. The service consumer data may be stored in Network Application System 300 or with the member of Consumers 310A-310C to which it applies.

Broker 330 is configured to act as an intermediary between Providers 320A-320C and Consumers 310A-310C. This intermediary action includes identification of the service consumer, determination of a service contract (if not already determined), implementation of the service contract during interaction between service providers and service consumers, and/or management of Providers 320A-320C. In various embodiments, Broker 330 is controlled by a party controlling a member of Consumers 310A-310C, controlled by a party controlling a member of Providers 320A-320C, or controlled by an independent third party. In some embodiments Broker 330 includes an application programming interface (API) configured as a plug-in interface for accessing Broker 330. The application programming interface is optionally static and programmed in advance to be compatible with possible contract terms.

Typically, Broker 330 includes an input/output configured to exchange data with Consumers 310A-310C and to exchange data with Providers 320A-320C. For example, in some embodiments Broker 330 includes a network adaptor configured to communicate with Provider 320A, and a web server accessible through Network 140. Broker 330 may also include a memory configured to store service contract data representative of a service contract currently in operation between a service consumer and a service provider. Typically, this service contract data is selected by Broker 330 using the identity of the service consumer. This selection process is described further herein.

In a typical embodiment, Broker 330 further includes one or more mechanisms to manage communication with other elements of Network Application System 300, to facilitate identification of the service consumer, to process consumer data (data passed between the service consumer and Broker 330), and to process provider data (data passed between the service provider and Broker 330). These mechanisms may include logic circuits, computer instructions, or the like. The consumer data and provider data are processed according to a service contract associated with the service consumer identity.

Network Application System 300 may also include an optional Configuration Engine 340. Configuration Engine 340 is configured to specify preferences, capabilities or limitations of one or more service consumers and, optionally, to specify a characteristic of a service provider. Service consumer data relating to these specifications is stored in a Data Storage 350. In some embodiments, service consumer data is entered manually through a user interface. In some embodiments, service consumer data is received from a service consumer, such as Consumer 310A. Data Storage 350 is optionally accessible from more than one service broker. In some embodiments, Data Storage 350 is further configured to store the specified characteristic of a service provider and/or is accessible through one or more of Providers 320A-320C. Optionally, Data Storage 350 may be further configured to serve other functions such as to serve as a cache of contract data to be looked up by a service broker at runtime, to serve as a temporary storage for data being communicated with Broker 330, to store computer instructions, to store data in an intermediate format during processing, or the like. In alternative embodiments, all or part of Configuration Engine 340 is associated with an independent third party or one of Consumers 310A-310C, rather than Network Application System 300 as shown in FIG. 3.

Configuration Engine 340 or Broker 330 are configured to use the service consumer data stored in Data Storage 350 to determine a service contract. For example, when service consumer data relating to preferences, and/or capabilities and limitations, of Consumer 310A are stored in Data Storage 350, Configuration Engine 340 may use this data to determine a contract between Consumer 310A and a service provider. The process of determining a contract is described further herein. In some embodiments, Configuration Engine 340 includes a user interface configured to show to a user details of a service contract. These details include specific service contract terms that are determined using preferences, and/or capabilities and limitations, of a service consumer.

A specific set of preferences, and/or capabilities and limitations associated with a specific service consumer is sometimes a subset of the data necessary to determine a complete contract. Thus, a specific set of preferences, capabilities or limitations may result in different sets of contract terms when used to establish contracts with different service providers. For example, service consumer data for Consumer 310B may include capabilities of communicating through two different protocols. A service contract between Consumer 310B and Provider 320A may include use of a first of these two different protocols, and a service contract between Consumer 310B and Provider 320B may include use of a second of these two different protocols. The user interface of Configuration Engine 340 may be used by a user to view these different contract terms, before, during, or after their use by Broker 330. Once specified, the service consumer data relating to a service consumer may be used to determine contracts (e.g., “service level agreements”) with a variety of different service providers. In some cases, these service providers are not identified until after the service consumer data is specified.

In some embodiments, Configuration Engine 340 is also configured to modify existing service consumer data. For example, Configuration Engine 340 may include an interface that enables a user to change service consumer data stored in Data Storage 350. Once service consumer data is modified, a service contract based on the original service consumer data may be automatically re-determined based on the new service consumer data. Thus, a change to the service consumer data stored in Data Storage 350 may result in changes to service contract terms in more than one service contract.

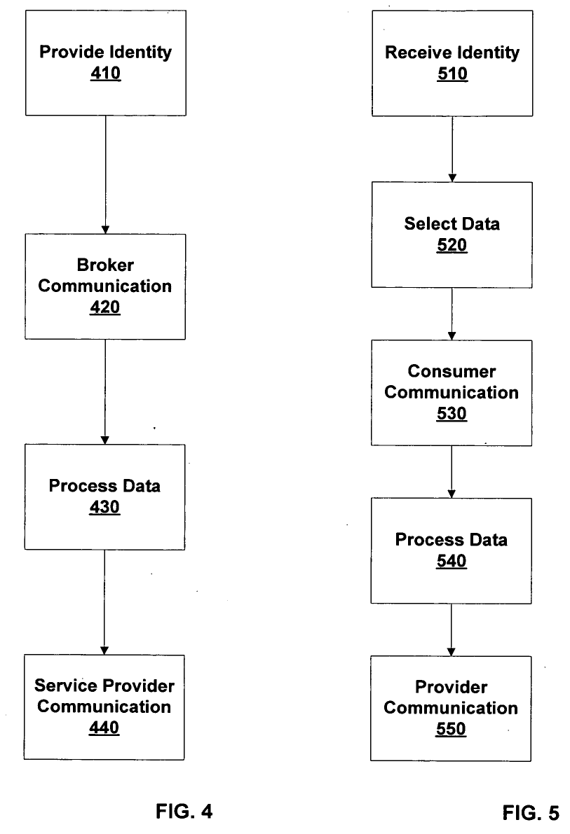

FIG. 4 is a flow chart illustrating various methods of operating Network Application System 300. In these methods, a service consumer provides identifying information to a service broker and the service broker uses the provided information to identify service contract data. The service contract data characterizes one or more service contract terms by which the interaction between the service consumer and service provider occurs. In some embodiments, this communication is through the service broker. Therefore, in these embodiments, the terms of the service contract may determine communication between the service broker and the service consumer, as well as between the service broker and the service provider. In some embodiments, further communication between the service consumer and the service provider does not need to occur through the service broker. In these embodiments, the terms of the service contract determine communication between the service provider and the service consumer.

In a Provide Identity Step 410, an identity of a service consumer, such as Consumer 310A, is provided to a service broker, such as Broker 330. This identity may be, for example, a user name, an account name, a hardware identification, a security certificate, cookie, URL fragment, or the like. Typically, the identity is provided by the service consumer. The identity is used by Broker 330 to select service contract data which is associated with the service consumer and characterizes a service contract. For example, in one embodiment, this selection includes Broker 330 sending the identity to Configuration Engine 340 along with a request that the identity be used to query Data Storage 350. If the query returns preexisting service contract data, then this data is provided to Broker 330 as the selection. If no preexisting service contract data is found, then Configuration Engine 340 is optionally configured to determine a service contract on demand, using predefined preferences, capabilities and/or limitations of the service consumer and a characteristic of a service provider. These predefined preferences, capabilities or limitations are typically stored in Data Storage 350.

In a Broker Communication Step 420 the service consumer communicates with the service broker under one or more terms of the service contract. This communication may occur through standard protocols such as HTTP, FTP, SMTP, or the like. The communication protocol may be specified by a term of the service contract. In one example, Broker Communication Step 420 includes transfer of one or more service contract terms from Broker 330 to Consumer 310A, and transfer of a data relating to a network application service from Consumer 310A to Broker 330. Both of these transfers may be under terms of the service contract.

In an optional Process Data Step 430, the service broker processes data received in Broker Communication Step 420, responsive to one or more terms of the service contract. The processing of this data is initiated by, for example, the identity determined in Provide Identity Step 410 or data communicated in Broker Communication Step 420. For example, in one embodiment Broker 330 performs a format conversion as specified by a term of the service contract. In one embodiment, Broker 330 selects a service provider to provide service in response to the data received in Broker Communication Step 420, responsive to a term of the service contract and responsive to load balancing information.

In a Service Provider Communication Step 440, the service broker communicates with a service provider. This communication is initiated responsive to the data received in Broker Communication Step 420 and/or Provide Identity Step 410. This communication is performed under a term of the service contract characterized by the service contract data selected using the identity provided in Provide Identity Step 410. For example, in various embodiments, data processed by Broker 330 in Process Data Step 430 is subsequently delivered from Broker 330 to a member of Service Providers 320A-320C in Service Provider Communication Step 440. Thus, Broker 330 may act as an intermediary for communications between members of Consumers 310A-310C and Providers 320A-320C.

In some embodiments, Broker Communication Step 420 and/or Service Provider Communication Step 440 include communication of terms of the service contract, selected in Provide Identity Step 410, from Broker 330 to Consumer 310A or to Provider 320A, respectively. For example, in one instance, terms of a preexisting service contract are sent to Provider 320A in Service Provider Communication Step 440. In another instance, terms of a service contract determined on demand are sent to Consumer 310A in Broker Communication Step 420. In some embodiments, further communications between Consumer 310A and Provider 320A, performed under at least one term of the service contract, do not include Broker 330 as an intermediary.

FIG. 5 is a flow chart illustrating further methods of operating Network Application System 300. In these methods an identity of a service consumer is received by Broker 330. This identity is used to select service contract data. Further communications with the service consumer are managed according to one or more service contract terms defined by the service contract data.

In a Receive Identity Step 510 a service broker, such as Broker 330, receives an identity of a service consumer. Typically, this identity is received from the service consumer and is associated with a request for a network application service. In some instances, the request is directed toward a specific service provider, such as Provider 320A. In other instances, the request is directed toward a specific type of service, such as a CRM service which may be provided by one or more of Providers 320A-320C.

In a Select Data Step 520, Broker 330 uses the identity received in Receive Identity Step 510 to select service contract data optionally stored in Data Storage 350. The service contract data is associated with a preference, capability and/or limitation of the service consumer and a characteristic of a service provider. The service provider, having the associated characteristic, is either a service provider specified in Receive Identity Step 510 or a service provider determined by Broker 330 as capable of providing the specific type of service requested. In some instances, the service contract data is previously prepared and stored in Data Storage 350. In other instances, this service contract data is generated on demand using previously stored preferences, capabilities and/or limitations of the service consumer, and a characteristic of a service provider.

In one embodiment, a specific service provider (having the “characteristic of a service provider” associated with the service contract data) is not identified prior to Select Data Step 520. For example, the characteristic may be “an ability to provide a CRM service” and Broker 330 may select any set of service contract data, associated with any service provider, that satisfies this characteristic and the preferences, capabilities or limitations of the service consumer.

In a Consumer Communication Step 530, communication takes place with the service consumer under at least one service contract term characterized by the service contract data selected in Select Data Step 520. This service contract term may include, for example, a preferred data format, a data transport protocol, a security scheme, a quality of service or performance requirement, or the like. Consumer Communication Step 530 optionally includes communication of information required for performing the requested service. For example, the communication may include financial data to be processed by an application service provider configured to perform accounting functions.

In an optional Process Data Step 540, data received in Consumer Communication Step 530 is processed by the service broker, responsive to one or more terms of the service contract characterized by the selected service contract data. For example, in one embodiment, Broker 330 receives a user identification and password sufficient to establish a secure communication session, and in response generates an authentication certificate in a form required by a service provider.

In a Provider Communication Step 550, communications occur with a service provider, such as Provider 320A, under at least one service contract term characterized by the service contract data selected in Select Data Step 520. In some embodiments, these communications occur between Broker 330 and Provider 320A. In other embodiments, these communications occur between Consumer 310A and Provider 320A, without necessarily passing through, or requiring further instruction from, Broker 330.

In various embodiments of the invention, a copy of service contract data selected responsive to a service consumer identity, such as in Select Data Step 520, is retrieved from Data Storage 350 and stored in Broker 330. This stored copy is optionally used for processing of data received from Consumer 310A or Producer 320A, for example, during Process Data Step 430 or Process Data Step 540. When this data is stored locally to Broker 330, it may be more efficiently accessed during use than when stored in Data Storage 350. In some cases the locally stored data is pre-compiled and stored in a pre-compiled form for run-time use. For example, in one embodiment, data is stored in Data Storage 350 in an Extended Markup Language (XML) format. Following selection, it is pre-compiled into an executable code callable through function calls or pointers during the processing of data.

In various embodiments, Process Data Step 430 or Process Data Step 540 are used many times as a service is provided by a service provider to a service consumer. For example, in some cases, Broker 330 receives communication from Consumer 310A, processes the received data responsive to a service contract term, and then sends the result of the processing to Provider 320A. In response, the Provider 320A sends a further communication back. This further communication is again processed responsive to a service contract term, and the result of processing the further communication is sent to Consumer 310A. This sequence of steps is optionally repeated as Provider 320A provides an application service to Consumer 310A.

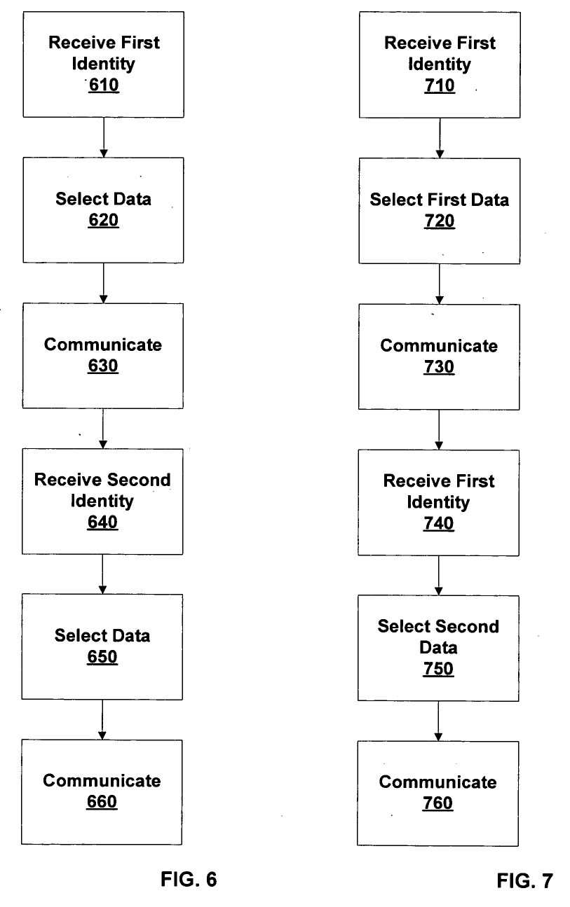

FIG. 6 illustrates various embodiments of the invention in which a service provider provides application services to more than one service consumer. The service may be provided under different service contract terms, responsive to the preferences, capabilities and/or limitations of each service consumer.

In a Receive First Identity Step 610, Broker 330 receives the identity of a first service consumer, such as Consumer 310A. This step is similar to Receive Identity Step 510. In a Select Data Step 620, service contract data is selected based on the consumer identity received in Receive First Identity Step 610 and a characteristic of a service provider. This characteristic of a service provider may be a preference, capability, limitation, or the like. For example, in one instance the characteristic includes a capability of providing the requested service and a preference for a communication protocol that is also preferred by the service consumer. In a Communicate Step 630, the application service is provided under at least one service contract term specified by the service contract data selected in Select Data Step 620. Communicate Step 630 typically includes communication between the service consumer and service provider, optionally through Broker 330.

In a Receive Second Identity Step 640, Broker 330 receives the identity of a second service consumer, such as Consumer 310B. This step is similar to Receive First identity Step 610 except that the second identity is different from the first identity. In a Select Data Step 650, service contract data is selected responsive to the identity of the second service consumer. The service contract data selected in Select Data Step 650 may be different from the service contract data selected in Select Data Step 620, even when the data is responsive to the same characteristic of a service provider. In a Communicate Step 660 an application service is provided to the second service consumer, based on the service contract data selected in Select Data Step 660.

FIG. 7 illustrates embodiments of the invention in which a service consumer obtains application services from two different service providers under different service contract terms. In a Receive First Identity Step 710, Broker 330 receives an identity of the service consumer. This step is similar to Receive First Identity Step 610. In Receive First Identity Step 710 Broker 330 also receives a request for a first application service, such as a finance service. This request may be directed toward a specific application service provider, such as Provider 320A, or Broker 330 may determine an appropriate service provider to provide the requested service.

In a Select First Data Step 720, the identity of the service consumer and a characteristic of a first service provider (either the specific service provider to which the request was directed or the service provider determined by Broker 330), are used to select service contract data characterizing at least one term of a first service contract.

In a Communicate Step 730, communication between the first service provider and the service consumer is used to deliver the requested application service to the service consumer. This communication is under terms of the first service contract.

In a Receive First Identity Step 740 the identity of the service consumer is again received by Broker 330. Broker 330 also receives a request for a second application service, such as a CRM service. In a Select Second Data Step 750, the identity of the service consumer and a characteristic of a second service provider (capable of providing the second application service), are used to select service contract data characterizing at least one term of a second service contract. The second service contract data selected in Select Second Data Step 750 is typically different than the first service contract data selected in Select First Data Step 720, even though they are both derived from the same preferences, capabilities or limitations of the service consumer.

In a Communicate Step 760, communication between the second service provider and the service consumer is used to deliver the requested second application service to the service consumer. This communication is under terms of the second service contract.

Several embodiments are specifically illustrated and/or described herein. However, it will be appreciated that modifications and variations are covered by the above teachings and within the scope of the appended claims without departing from the spirit and intended scope thereof. For example, a service consumer not yet associated with an identity may provide preferences, capabilities or limitations to a service broker and the service broker may assign a new identity, store the provided data, and determine a service contract on demand. Further, contract terms may be associated with logging rules, custom alerts, access control, load balancing, or the like.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A network application system comprising:
a service broker configured to act as an intermediary between a service provider and a service consumer, the service consumer having an identity and being characterized by
a) a consumer preference, and/or
b) a consumer limitation and a consumer capability, the service broker including
an input/output configured to exchange service consumer data with the service consumer and to exchange provider data with the service provider,
a memory configured to store service contract data selected using the service consumer identity and generated responsive to a characteristic of the service provider and the consumer preference, consumer limitation or consumer capability, of the service consumer, and
a mechanism configured to use the contract data to process the service consumer data and the provider data according to the service contract data.

2. The network application system of claim 1, wherein one of the one or more service providers is configured to provide customer relationship management services and another of the one or more service providers is configured to provide financial services.

3. The network application system of claim 1, wherein the consumer interaction preference is a security scheme preference.

4. The network application system of claim 1, wherein the consumer capability is an encryption capability.

5. The network application system of claim 1, wherein the consumer limitation is a communication protocol limitation.

6. The network application system of claim 1, wherein the consumer limitation or the consumer preference is a performance requirement.

7. The network application system of claim 1, wherein the consumer limitation or the consumer preference is a quality of service requirement.

8. The network application system of claim 1, wherein the service broker is configured to exchange data with more than one service provider.

9. The network application system of claim 1, further including a configuration engine configured to store the consumer preference, the consumer limitation or the consumer capability, prior to generation of the service contract data.

10. The network application system of claim 1, wherein the service contract data may be automatically generated at the time of a service request.

11. The network application system of claim 1, wherein the service consumer is a web portal.

12. The network application system of claim 1, further including one or more service providers accessible through the service broker.

13. A method of operating a network application system, the method comprising:
providing a service consumer identity to a service broker, the service consumer identity configured for the service broker to select first service contract data characterizing a first service contract, the selected first service contract data being responsive to a preference, a capability or a limitation of the service consumer, and a characteristic of a service provider; and
communicating between the service consumer and the service provider response to a term of the first service contract.

14. The method of claim 13, wherein communicating between the service consumer and the service providers includes communicating between the service consumer and the broker under a term of the first service contract, and causing the service broker to communicate with the service provider under a term of the first service contract.

15. The method of claim 13, further including using the service broker to process data received from the service consumer or received from the service provider, according to a term of the first service contract.

16. The method of claim 13, further including again providing the service consumer identity to the service broker, and providing the service broker with a request for an application service, the service consumer identity and request for an application service being configured for the service broker to select second service contract data characterizing a second service contract, the second service contract data being different than the first service contract data.

17. The method of claim 16, wherein the first service contract data and the second service contract data are both responsive to the same preference, capability or limitation of the service consumer.

18. A method of operating a network application system, the method comprising:
receiving a service consumer identity from a service consumer, the service consumer identity configured for selecting service contract data;
selecting first service contract data responsive to the service consumer identity, the selected first service contract data being responsive to a preference, a capability or a limitation of the service consumer and a characteristic of a service provider;
communicating with the service consumer under a service contract term characterized by the service contract data; and
communicating with the service provider under a service contract term characterized by the service contract data.

19. The method of claim 18, further including processing data received from the service consumer or the service provider, responsive to a service contract term characterized by the service contract data.

20. The method of claim 18, further including processing data received from the service consumer or the service provider, responsive to a service contract term characterized by the service contract data, the processing including transformation of a data format.

21. The method of claim 18, further including processing data received from the service consumer or the service provider, responsive to a service contract term characterized by the service contract data, the processing including decryption.

22. The method of claim 18, further including retrieving the selected service contract data from a data storage, and pre-compiling the selected service contract data.

23. The method of claim 18, further including selecting the service provider responsive to a service requested by the service consumer.

24. The method of claim 18, further including selecting the service provider responsive to a service requested by the service consumer, wherein the service request is for a service selected from a set of services including at least a customer relationship management service and an enterprise resource planning service.

25. The method of claim 18, wherein the first service contract data is further responsive to a preference, a capability and a limitation of the service consumer.

26. The method of claim 18, wherein the step of communicating with the service provider or the step of communicating with the service consumer is performed using an application programming interface.

27. A method of operating a network application system, the method comprising:
receiving a service consumer identity from a service consumer;
selecting service contract data from a plurality of service contract data using the service consumer identity, the selected service contract data being responsive to a preference, a capability and a limitation of the service consumer, and a characteristic of a service provider;
storing the service contract data in local memory in a pre-compiled format;
receiving first communications from the service consumer;
processing the first communications using the stored service contract data;
sending a result of processing the first communications to the service provider;
receiving second communications from the service provider responsive to the sent result of processing the first communication;
processing the second communications using the stored service contract data; and
sending a result of processing the second communications to the service consumer.

28. A method of operating a network application system, the method comprising:
receiving a first service consumer identity from a first service consumer, the first service consumer identity configured for selecting first service contract data, the selected first service contract data being previously determined using a configuration engine responsive to a preference, a capability or a limitation of the first service consumer, and a characteristic of a first service provider, the preference including a preferred data format, the capability including an encryption capability, and the limitation concerning a communication protocol;
pre-compiling the first service contract data for run-time use;
communicating between the first service consumer and the first service provider based on the pre-compiled first service contract data;
receiving a second service consumer identity from a second service consumer, the second service consumer identity configured for selecting second service contract data, the selected second service contract data being different than the selected first service contract data and being configured to specify terms by which the first service provider provides services to the second service consumer;
pre-compiling the second service contract data for run-time use; and
communicating between the second service consumer and the first service provider based on the second service contract data.

29. A method of operating a network application system, the method comprising:
receiving a first service consumer identity from a first service consumer, the first service consumer identity configured for selecting service contract data previously determined using a configuration engine responsive to a preference, a capability or a limitation of the first service consumer, and a characteristic of a service provider;
receiving a first service request from the first service consumer;
selecting a first service provider responsive to the first service request, the first service provider having a characteristic;
selecting first service contract data responsive to the service consumer identity and the characteristic of the first service provider;
communicating between the first service consumer and the first service provider based on the selected first service contract data;
receiving again the first service consumer identity from the first service consumer;
receiving a second service request from the first service consumer;
selecting a second service provider responsive to the second service request, the second service provider having a characteristic;
selecting second service contract data responsive to the service consumer identity and the characteristic of the second service provider, the second service contract data being different than the first service contract data, both the first service contract data and the second service contract data being responsive to a preference, a capability or a limitation of the service consumer; and
communicating between the first service consumer and the second service provider based on the selected second service contract data.

30. The method of claim 29, wherein the preference includes a preferred data format, the capability includes an encryption capability, or the limitation concerns a communication protocol.

31. The method of claim 29, wherein the first service request is for a different type of service than the second service request.

32. The method of claim 29, wherein selecting the first service contract data and selecting the second service contract data are both responsive to the same preference, capability or limitation.

33. A system comprising:
means for receiving a service consumer identity from a service consumer, the service consumer identity configured for selecting service contract data;
means for selecting first service contract data responsive to the service consumer identity, the selected first service contract data being responsive to a preference, a capability or a limitation of the service consumer and a characteristic of a service provider;
means for communicating with the service consumer under a service contract term characterized by the service contract data; and
means for communicating with the service provider under a service contract term characterized by the service contract data.

34. A computer readable medium having thereupon computer instructions comprising:
a code segment configured for receiving a service consumer identity from a service consumer, the service consumer identity configured for selecting service contract data;
a code segment configure for selecting first service contract data responsive to the service consumer identity, the selected first service contract data being responsive to a preference, a capability or a limitation of the service consumer and a characteristic of a service provider;
a code segment configure for communicating with the service consumer under a service contract term characterized by the service contract data; and
a code segment configure for communicating with the service provider under a service contract term characterized by the service contract data.
